(19) United States
(12) Patent Application Publication
(10) Pub. No.: US 2026/0043194 A1
(43) Pub. Date: Feb. 12, 2026

(54) DEVICE AND METHOD FOR CONNECTING FINITE MATERIAL WEBS

(71) Applicant: KÖRBER TECHNOLOGIES GMBH, HAMBURG (DE)

(72) Inventors: Matthias HORN, AHRENSBURG (DE); Karl Richard BUSCH, HAMBURG (DE); Michael HAUL, KRÖPPELSHAGEN (DE); Axel HENNING, OSTSTEINBEK (DE)

(21) Appl. No.: 19/100,002

(22) PCT Filed: Jul. 25, 2023
(86) PCT No.: PCT/EP2023/070602

§ 371 Date: Jan. 30, 2025

(30) Foreign Application Priority Data
Aug. 1, 2022 (DE) 10 2022 119 215.6

(51) Int. Cl. D06H 5/00; H01M 4/04

(52) U.S. Cl. CPC D06H 5/001; H01M 4/04; D10B 2505/00

(57) ABSTRACT

The invention relates to a device and a method for connecting finite webs of material for the energy cell producing industry, wherein the device comprises a holding device adapted to hold the new web of material by means of negative pressure in the second guide section, as well as a backing element and a cutting element, downstream in the conveying direction of the holding device. The backing element and the cutting element are adapted to cut the stationary new web of material to produce a new leading end of the new web of material. The device also comprises an applicator for applying an adhesive strip to the new leading end of the new web of material and a ram and a cutting device, wherein the cutting device is adapted to cut the stationary running-out web of material to produce a new trailing end of the running-out web of material. The ram is adapted to press the trailing web end of the running-out web of material onto the adhesive strip and against the applicator in order to connect the new leading end of the new web of material to the new trailing end of the running-out web of material.

The present invention relates to a device for connecting finite material webs for the energy cell producing industry and a method for connecting finite material webs for the energy cell producing industry.

Energy cells or energy storage devices in the sense of the invention are used, for example, in motor vehicles, other land vehicles, ships, aircraft or also in stationary systems, such as in the form of battery cells or fuel cells, in which very large amounts of energy have to be stored over long periods of time. For this purpose, such energy cells comprise a structure of layered materials, which usually consist of an anode material on a conductor foil and a cathode material on a conductor foil and a separator foil, wherein the separator foil is arranged between the anode material and the cathode material. Such a material composite can be present in an energy cell in a stacked, rolled or folded arrangement.

To achieve a high production speed, the materials for the anode, cathode and separator are processed as material webs as far as possible. These material webs, which may be semi-finished or also intermediate products, are usually supplied as bobbins or coils or transported in this form between different production facilities. Bobbins inevitably comprise a limited length of web. To maximize the production rate and thus minimize production costs, it is advantageous to have a continuous production process with a high speed and an endless web, so that each web of material that runs out is connected to new web of material. To ensure continuous production, process storages or buffer storages are known, which provide a buffer so that the connection of two webs of material can be produced to achieve an endless web, while the further production process is carried out with the web of material from the buffer storage. Increasing production speeds in the manufacture of energy cells, for example Li-ion batteries, cannot be compensated for by ever larger buffer storages, so that the connection process must be carried out as quickly as possible.

Furthermore, the joints between two webs of material in the endless web can be problematic in the further course of the process, so that the joints should differ as little as possible from the further parts of the web of material.

The object of the invention is therefore to provide a device and a method that enable a fast and efficient connection of webs of material to an endless web.

The object is realized by the features of the independent claims. Further preferred embodiments of the invention are set out in the dependent claims, the figures and the associated description.

A device for connecting finite webs of material is proposed for the energy cell producing industry, wherein a running-out web of material can be guided in a first guide section and a new web of material can be guided in a second guide section. The running-out web of material and the new web of material can be conveyed in a conveying direction. The device comprises a holding device which is adapted to hold the new web of material in the second guide section by means of negative pressure. The device further comprises a backing element and a cutting element, downstream in the conveying direction of the holding device, wherein the backing element and the cutting element are adapted to cut the stationary new web of material to produce a new leading end of the new web of material. The device also comprises an applicator for applying an adhesive strip to the new leading end of the new web of material, and a ram and a cutting device. The cutting device is adapted to cut the stationary running-out web of material to produce a new trailing end of the running-out web of material. The ram is adapted to press the trailing end of the running-out web of material onto the adhesive strip and against the applicator in order to connect the new leading end of the new web of material to the new trailing end of the running-out web of material.

With the proposed device, a high-quality connection can be quickly made between a running-out and a new web of material, so that the production process is only minimally interrupted.

The devices preferably comprise a buffer storage or process storage for the running-out web of material.

Due to the short interruption of the conveying of the endless web of material during the production of the connection, the buffer storage can be designed smaller and/or the conveying speed of the endless web of material can be increased and thus also the production speed for the production of energy cells.

The proposed device is suitable for producing a so-called static splice, in which the conveying speed during the production of the connection by the adhesive strip is temporarily reduced to zero.

Furthermore, the device enables a connection of the running-out web of material with the new web of material to be made with an abutting joint, so that there is no overlap of the two webs of material at the joint. This helps to prevent disruptions in the further production process of the energy cells by avoiding the doubling of the material thickness due to an overlap of the webs of material. The material build-up due to the adhesive tape is comparatively low. The device is particularly suitable for comparatively thick webs of material of an energy cell, for example a conductor foil coated with anode or cathode material.

The adhesive tape is preferably glued to the uncoated side of the conductor foil coated with anode or cathode material. Furthermore, the running-out web of material and the new web of material are guided largely in parallel in the first and second guide sections before the connection.

In advantageous embodiments, the applicator picks up the adhesive tape from a supply unit. Furthermore, the applicator is preferably pivotable or arranged on a pivot element. The adhesive tape can be picked up from the supply unit by the applicator, for example by means of a negative pressure, and held until it is applied to the new leading end of the new web of material and, if necessary, until it is applied to the new trailing end of the running-out web of material.

The new trailing end of the running-out web of material is that end of the running-out web of material that is conveyed further in the conveying direction in the device and is connected to the new leading end of the new web of material. The original end of the running-out web of material is usually linked to the bobbin on which the rest of the web of material remains until the running-out web of material is cut. The bobbin with the remaining part of the running-out web of material can then be removed. Accordingly, after the running-out web of material has been connected to the new web of material, the new web of material becomes a running-out web of material, so that an endless web of material can be produced in the device.

In a preferred embodiment, the backing element is movable for bearing against the new material web. In this case, the backing element is preferably swung into the plane of the guide section of the new material web, for example from a rear wall of the device. This makes it easier to lay or prepare the new material web. Furthermore, unnecessary collisions can be avoided in this way. The backing element is preferably arranged to bear against the new web of material on the opposite side of the holding device.

The backing element is preferably arranged or can be arranged between the running-out web of material and the new web of material. The backing element is therefore preferably movable between the first guide section of the running-out web of material and the second guide section of the new web of material or is fixedly arranged in the latter.

In a possible alternative embodiment, the cutting element is arranged between the second guide section of the new web of material and the first guide section of the running-out web of material, or is displaceable and/or pivotable into such an arrangement. In this possible alternative embodiment, the backing element is arranged on the other side of the new web of material.

According to a further development, it is proposed that the backing element is provided as an abutment for the applicator to apply the adhesive strip to the new leading end of the new web of material.

In possible embodiments, the backing element can therefore serve not only as a counterholder for cutting the new web of material but also as a counterholder for applying the adhesive strip to the new web of material. By integrating both functions, the device can be kept comparatively simple.

According to a further development, it is proposed that the backing element and the cutting device are adapted to cut the running-out web of material. The backing element can therefore take on further functions in advantageous embodiments, wherein the cut of the running-out web of material with the cutting device is preferably made against a different edge of the backing element compared to the cutting of the new web of material by the cutting element. In possible embodiments, however, both cuts can be made at different edges of the same surface of the backing element.

Preferably, the ram and the cutting device are firmly connected to one another or the cutting device is arranged on the ram so that the ram is moved together with the cutting device. Further preferably, the ram and the cutting device are axially displaceable in the direction of the running-out web of material. In preferred embodiments, the ram comes into contact with the running-out web of material in front of the cutting device, which may be in the form of a knife, for example, when the ram and the cutting device are displaced axially. It is therefore preferable for the ram to project with respect to the cutting device. It is particularly advantageous if a distance is provided between the ram and the cutting device. Furthermore, it is preferred if the ram is arranged in front of the cutting device in the conveying direction.

According to a preferred embodiment, it is proposed that the running-out web of material is guided on two rollers in the first guide section and/or the new web of material is guided on two rollers in the second guide section. Preferably, the new and the running-out web of material can be guided in parallel in this section.

According to a further development, it is proposed that a pretensioning unit is provided for rolling up and tensioning the leading end of the new web of material. Thus, the new web of material can be tensioned in the second guide section, in particular between the rollers, to such an extent that good guidance and a distinct position of the new web of material can be achieved in the second guide section. This improves in particular the quality of the cut made by the cutting element against the backing element.

According to a further development, it is proposed that a bobbin opener is provided, which is adapted to pick up the leading end of the new web of material from a bobbin, to guide it through the second guide section and to transfer it to the pretensioning element.

This allows a high degree of automation to be achieved, whereby the conveying speed of the running-out web of material does not have to be reduced or even stopped during these preparation steps. The bobbin opener is preferably pivotally mounted or arranged on a pivot element and preferably comprises the same axis of rotation as the applicator.

The leading end of the new web of material usually corresponds to the outer end of a new web of material on a bobbin. The new web of material is cut in the device, producing a new leading end. The section with the original leading end of the new web of material, which is adjacent to the forerun, is therefore not conveyed in the conveying direction and forms a remainder.

Furthermore, a method for connecting finite webs of material for the energy cell producing industry with a device according to any one of claims 1 to 9 with the following steps is proposed for solving the task:
conveying a running-out web of material in the first guide section in a conveying direction;
holding the new web of material in the second guide section by means of negative pressure by means of a holding device;
cutting the new web of material, downstream in the conveying direction of the holding device, by means of the backing element and the cutting element and producing a new leading end of the new web of material;
applying an adhesive strip to the new leading end of the new web of material by means of the applicator;
stopping the running-out web of material in the first guide section;
cutting the running-out web of material and producing a new trailing end of the running-out web of material by means of the cutting device;
pressing the trailing end of the running-out web of material by means of the ram onto the adhesive strip and against the applicator and connecting the new leading end of the new web of material to the new trailing end of the running-out web of material;
conveying the new web of material.

The proposed method enables the quick and automated connection of two finite webs of material for the production of energy cells, in particular battery cells.

According to a further development, the following steps are proposed before the holding device holds the new web of material:
picking up the leading end of the new web of material from a bobbin;
guiding the new web of material through the second guide section;
transferring the leading end of the new web of material to a pretensioning unit and tensioning the new web of material in the second guide section.

This allows the entire splicing process to be automated after a new bobbin with a new web of material has been loaded.

The invention will be explained below with reference to preferred embodiments with reference to the accompanying figures. Therein show

FIG. 1-5 a device for connecting finite webs of material in different operating states before the webs of material are connected;

FIG. 6 two webs of material connected by an adhesive strip, as seen from the front;

FIG. 7 two webs of material connected by an adhesive strip, as seen from the back; and

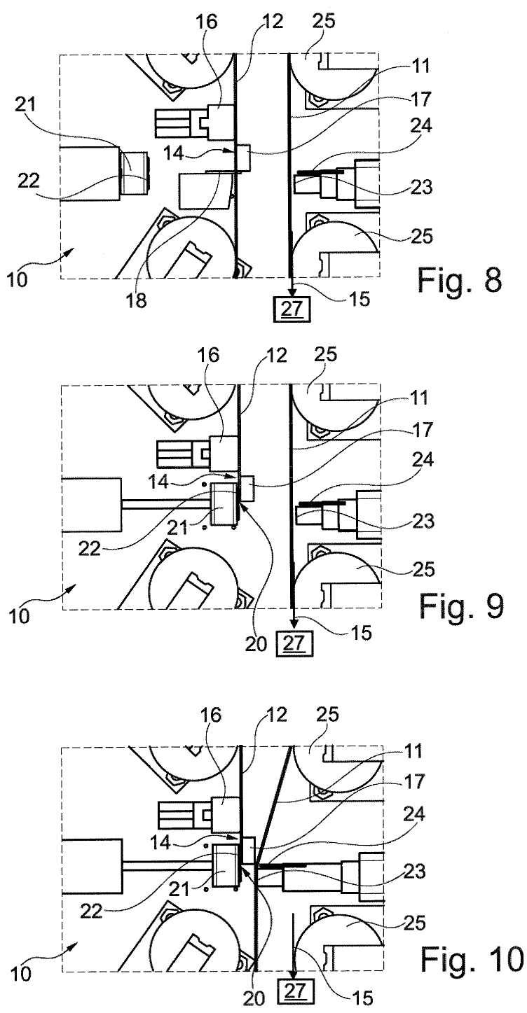

FIG. 8-13 detailed views of a device for connecting two webs of material in different operating states during connection.

FIGS. 1 to 5 show a device 10 for connecting finite webs of material 11, 12 for the industry producing energy cells, in particular battery cells. A web of material 11 is unwound from a bobbin 30 and fed in the unwound state via a first guide section 13 and via a buffer storage 27 for the web of material 11 to further production steps. The web of material 11 is supplied from a bobbin 30, so that the web of material 11 is a finite web of material 11. Furthermore, the web of material 11, which is fed to the buffer storage 27 or to further process steps for the production of energy cells, is a running-out web of material 11. To produce an endless web of material 11, 12, the running-out web of material 11 is connected to a new web of material 12 by the device 10. The new web of material 12 is supplied from a new bobbin 30, which is placed on a turntable 32 of the device 10 together with the bobbin 30 of the running-out web of material 12. The running-out web of material 11 is conveyed in the conveying direction 15 to a buffer storage 27 by a first guide section 13, which in this embodiment is formed by two rollers 25. The buffer storage 27 makes it possible to stop the running-out web of material 11 briefly in the area of the first guide section 13 and at the same time to make the running-out web of material 11 continuously available to subsequent processes for the production of energy cells.

FIG. 1 shows the device 10 in an operating state in which a new bobbin 30 with a new web of material 12 is placed on the turntable 32. An applicator 21, which is designed as a pivoting arm, is first moved to a transfer position opposite a supply unit 33 for adhesive strips 22.

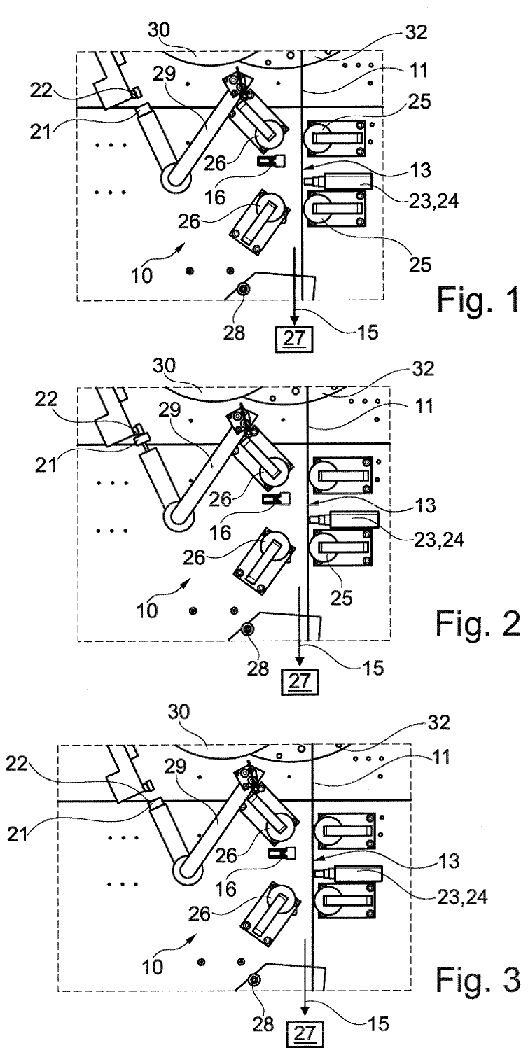

In FIG. 2, the applicator 21 is moved to the supply unit 33, as a result of which an adhesive tape 22 for connecting the running-out web of material 11 to the new web of material 12 can be taken over by the applicator 22, which can be fixed, for example, by means of a negative pressure. The applicator 21 with the adhesive tape 22 is then available in a waiting position, see FIG. 3, for connecting the running-out web of material 11 to the new web of material 12.

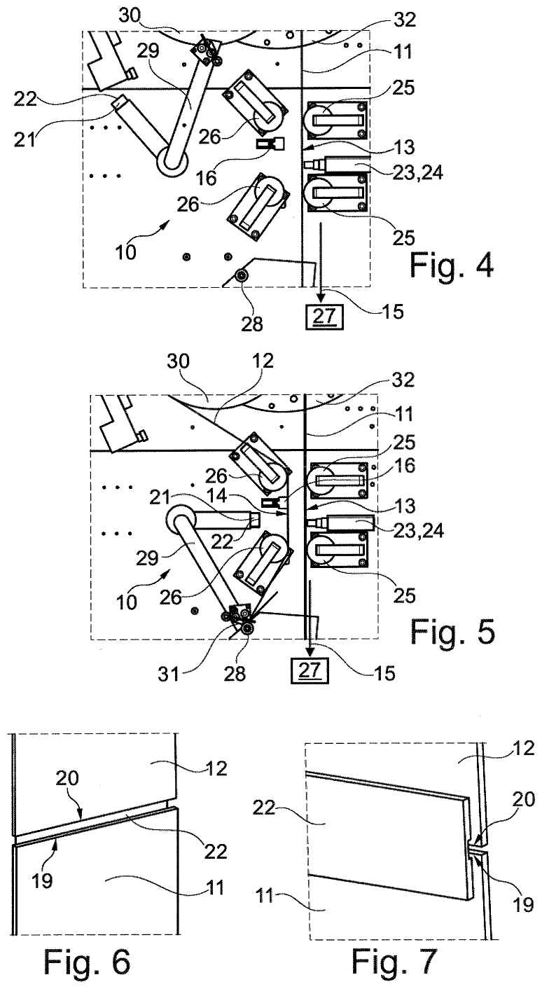

FIGS. 4 and 5 show further preparation steps for connecting the running-out web of material 11 to the new web of material 12. For this purpose, a bobbin opener 29, which in this advantageous embodiment comprises a common axis of rotation with the applicator 21, opens the bobbin 30 with the new web of material 12, as illustrated in FIG. 4. The bobbin opener 29 picks up the leading end 31 of the new web of material 12 and guides the new web of material 12 through the second guide section 14, which in this advantageous embodiment is formed by two rollers 26, to a pretensioning unit 28. The pretensioning unit 28 serves to tension the new web of material 12 so that it rests in a defined and tensioned manner on the rollers 26 in the second guide section 13, see FIG. 5. Furthermore, wrapping paper or, in general, a first layer of the bobbin 30 can be wound and disposed of by means of the pretensioning unit 28.

During the steps and operating states of the device 10 shown in FIGS. 1 to 5, the running-out web of material 11 can continue to be supplied to the buffer storage 27.

FIGS. 6 and 7 show a connection between a running-out web of material 11 and a new web of material 12, which was produced with a device 10, in detailed views from the front and back of the web of material 11, 12. The running-out web of material 11 is connected to the new web of material 12 in a butt-jointed manner, i.e. without overlapping. The adhesive strip 22 is glued both to the running-out web of material 11 and to the new web of material 12 and therefore connects the webs of material 11, 12, whereby an endless web of material 11, 12 can be produced. The connection on the running-out web of material 12 is made at a new trailing end 19, which does not correspond to the original trailing end of the running-out web of material 11 on the bobbin 30. Furthermore, the connection is made on the new web of material 12 at a new leading end 20, which does not correspond to the original leading end 31 on the bobbin 30 with the new web of material 12, which is explained on the basis of the further FIGS. 8 to 13, which show the connection process with the device 10 in a detailed view of the device 10.

FIG. 8 shows the device 10 in a state after the preparations according to FIGS. 1 to 5. Accordingly, the running-out web of material 11 can continue to be conveyed in the conveying direction 15. A holding device 16 contacts the new web of material 12 in the second guide section 14 and holds it by means of a negative pressure. In this advantageous embodiment, a backing element 17 and a cutting element 18 are swung out of the rear wall of the device 10, downstream in the conveying direction 15 of the holding device 16. In this embodiment, the backing element 17 comes into contact with the new web of material 12 on the other side of the new web of material 12 compared to the holding device 16. The cutting element 18 is arranged on the same side of the new web of material 12 as the holding device 16. The cutting element 18, in conjunction with the backing element 17, cuts the new web of material 12, thereby forming a new leading end 20 of the new web of material 12. The cut-off forerun of the new web of material 12 can be wound up by the pretensioning unit 28 and then disposed of. The new leading end 20 is held in position by the holding device 16 and, in this advantageous embodiment, the cutting element 18 is folded back into the rear wall of the device 10.

As can be seen in FIG. 9, the backing element 17 initially remains in position, in contrast to the cutting element 18. The applicator 21, on which the adhesive tape 22 is held, applies a part of the adhesive tape 22 to the new web of material 12 at the new leading end 20, wherein the backing element 17 serves as a counter-bearing for the applicator 21 for pressing the adhesive tape 22 onto the new web of material 12. The further part of the adhesive strip 22 has the adhesive side exposed in the conveying direction 15 behind the new leading end 20 of the new web of material 12. The non-adhesive rear side is preferably held further by the applicator 21.

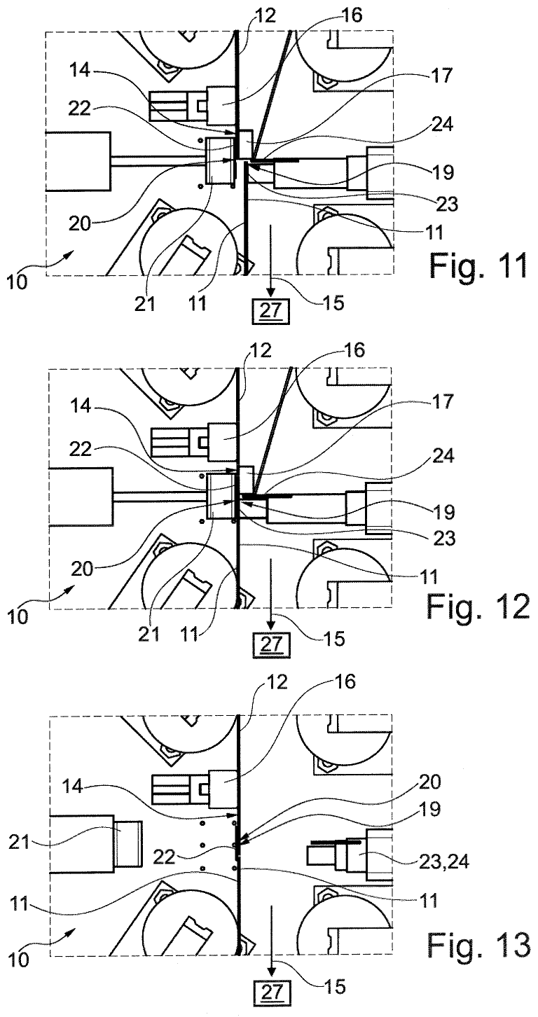

FIG. 10 shows the device 10 during the joining process, in which the running-out web of material 11 has been stopped and is stationary. Accordingly, subsequent processes for producing energy cells can be supplied from the buffer storage 27. The running-out web of material 11 is deflected in the first guide section by a ram 23 in the direction of the new web of material 12. In this case, the ram 23 is arranged behind the backing element 17 in the conveying direction 15. The ram 23 is provided with a cutting device 24, which is arranged between the ram 23 and the backing element 17 with respect to the conveying direction 15. The cutting device 24 is set back with respect to the ram 23, so that during the displacement of the running-out web of material 11, initially only the ram 23 comes into contact with the running-out web of material 11. As the displacement progresses, the running-out web of material 11 comes into contact with the backing element 17, as can be seen in FIG. 11. As the ram 23 with cutting device 24 continues to move, the cutting device 24, in conjunction with the backing element 17, cuts the running-out web of material 12, forming a new trailing end 19.

FIG. 12 shows how the ram 23 presses the new trailing end 19 onto the free part of the adhesive strip 22 after the cutting operation, wherein the applicator 22 supports the back of the adhesive strip 22. The running-out web of material 11 is connected to the new web of material 12 by means of the adhesive strip 22.

FIG. 13 shows the device 10 in a subsequent step. The ram 23 with the cutting device 24 has been retracted back to the starting position and the backing element 17 has been folded back into the rear wall of the device 10. The applicator 21 is separated from the adhesive strip 22 and moved back. No negative pressure is applied to the holding device 16. Furthermore, the rest of the running-out web of material 11 has been wound back onto the bobbins 30. Accordingly, the connected web of material 11, 12 can be conveyed again at the process speed in the conveying direction 15. The connected web of material 11, 12 can also be conveyed intermittently at overspeed in the conveying direction in order to refill the buffer storage 27. The turntable 32 with the bobbins 30 can also be turned in such a way that the new web of material 12 takes over the course of the running-out web of material 11 after the connection and is guided in the first guide section on the rollers 26.

### LIST OF REFERENCE SIGNS

10 device
11 running-out web of material
12 new web of material
13 first guide section
14 second guide section
15 conveying direction
16 holding device
17 backing element
18 cutting element
19 new trailing end
20 new leading end
21 applicator
22 adhesive tape
23 ram
24 cutting device
25 roller
26 roller
27 buffer storage
28 pretensioning unit
29 bobbin opener
30 bobbin
31 leading end
32 turntable
33 supply unit

1. A device for connecting finite webs of material for the energy cell producing industry, wherein
a running-out web of material can be guided in a first guide section and a new web of material can be guided in a second guide section, wherein
the running-out web of material and the new web of material can be conveyed in a conveying direction, and the device comprises:
a holding device which is adapted to hold the new web of material in the second guide section by means of negative pressure,
a backing element and a cutting element, downstream in the conveying direction of the holding device, wherein the backing element and the cutting element are adapted to cut the stationary new web of material to produce a new leading end of the new web of material,
an applicator for applying an adhesive strip to the new leading end of the new web of material, and
a ram and a cutting device, wherein the cutting device is adapted to cut the stationary running-out web of material to produce a new trailing end of the running-out web of material, and wherein
the ram is adapted to press the trailing end of the running-out web of material onto the adhesive strip and against the applicator in order to connect the new leading end of the new web of material to the new trailing end of the running-out web of material.

2. The device according to claim 1, wherein the backing element is movable for bearing against the new web of material.

3. The device according to claim 1, wherein the backing element is arranged or can be arranged between the running-out web of material and the new web of material.

4. The device according to any one of claim 1, wherein the backing element is provided as an abutment for the applicator to apply the adhesive strip to the new leading end of the new web of material.

5. The device according to claim 1, wherein the backing element and the cutting device are adapted to cut the running-out web of material.

6. The device according to claim 1, wherein the running-out web of material is guided in the first guide section on two rollers and/or the new web of material is guided in the second guide section on two rollers.

7. The device according to claim 1, wherein a buffer storage is provided for the running-out web of material.

8. The device according to claim 1, wherein a pretensioning unit is provided for rolling up and tensioning the leading end of the new web of material.

9. The device according to claim 1, wherein a bobbin opener is provided, which is adapted to pick up a leading end of the new web of material from a bobbin, to guide it through the second guide section and to transfer it to the pretensioning element.

10. A method for connecting finite webs of material for the energy cell producing industry with a device according to claim 1, wherein the method comprises the following steps:
conveying a running-out web of material in the first guide section in a conveying direction;
holding the new web of material in the second guide section by means of negative pressure by means of a holding device;
cutting the new web of material, downstream in the conveying direction of the holding device, by means of the backing element and the cutting element and producing a new leading end of the new web of material;
applying an adhesive strip to the new leading end of the new web of material by means of the applicator;
stopping the running-out web of material in the first guide section;
cutting the running-out web of material and producing a new trailing end of the running-out web of material by means of the cutting device;
pressing the trailing end of the running-out web of material by means of the ram onto the adhesive strip and against the applicator and connecting the new leading end of the new web of material to the new trailing end of the running-out web of material; and
conveying the new web of material.

11. The method according to claim 10, comprising, before the holding device holds the new web of material, the steps:
picking up the leading end of the new web of material from a bobbin;
guiding the new web of material through the second guide section; and
transferring the leading end of the new web of material to a pretensioning unit and tensioning the new web of material in the second guide section.
